(19) United States
(12) Patent Application Publication
(10) Pub. No.: US 2014/0298008 A1
(43) Pub. Date: Oct. 2, 2014

(54) Control System Security Appliance

(71) Applicant: National Oilwell Varco, L.P., (US)

(72) Inventor: Kent Erin Hulick, Houston, TX (US)

(73) Assignee: National Oilwell Varco, L.P., Houston, TX (US)

(21) Appl. No.: 13/851,597

(22) Filed: Mar. 27, 2013

(51) Int. Cl. H04L 29/06

(52) U.S. Cl. CPC H04L 63/0457
USPC 713/155

(57) ABSTRACT

A widespread security strategy for industrial control networks is physical isolation of the network, also known as an “air gap.” But the network might still be infected with unauthorized software if, say, an infected USB drive were to be plugged into one of the network's computers. The invention relates to a security module placed between the network and a device in the network. Each security module in the network mimics the Internet protocol (IP) configuration of its protected device. Each security module includes a private encryption key and a signed public key that it automatically shares with other security modules discovered on the network. These keys permit the security module to perform asymmetric point-to-point encryption of traffic from the protected device to the corresponding security module for a target device node and to detect (and thus block) unauthorized devices.

CAPITALIZED TERMS: For convenient reference, some instances of particular terms in the body of various paragraphs below and in the claims are presented in all-capital letters. This serves as a reminder that the all-caps terms are explained in more detail in the Glossary below. Not all instances of an all-caps term are necessarily presented in all-capital letters, though; that fact should not be interpreted as indicating that such other instances have a different meaning.

### 1. BACKGROUND OF THE INVENTION

Cyber security is a serious concern for today's industrial manufacturers. Automated control systems provide dramatic increases in productivity, but also provide significant potential targets for cyber weapons.

The invention relates to an improved system and method for enhancing the security of industrial control networks, sometimes referred to as ICNs.

As shown in FIG. 1, industrial control networks 100 typically include some or all of input/output (I/O) nodes; supervisory control and data acquisition (SCADA) computers; programmable logic controllers (PLCs); control computers; removable media such as USB thumb drives; diagnostic laptops; and so forth.

A prevailing security strategy for industrial control systems is physical isolation of the industrial control network, also known as an “air gap,” to prevent access to critical control infrastructure. Due to the need for high speed, reliability, and determinism of control, isolated control networks often have little or no other security in place.

Isolation of a network, however, is not always a completely-effective security strategy. For example, the isolated network might be infected with a virus, worm, or other unauthorized software agent if, say, an infected USB thumb drive were to be plugged into one of the isolated network's computers or other devices. Similarly, suppose that a service worker, in performing diagnostics or maintenance on an isolated network, were to plug in an “out-side” laptop that contained a virus, worm, etc. That action might result in infection of one or more devices that form part of the supposedly-isolated network.

To use an analogy: Suppose that a hospital patient is being kept in the intensive-care unit (ICU), with the hospital staff making a serious effort to keep the patient from being exposed to outside germs. Suppose also that a doctor, heading for the ICU to check on the patient, has recently shaken hands with a visitor who has a bad cold. Finally, suppose that the doctor comes into the patient's room and—without washing his hands—shakes hands with the patient. The patient might very well catch the visitor's cold, even though the hospital staff has been making efforts to keep the patient isolated from the outside world.

Knowing this, an attacker might intentionally target the patient, despite the patient's isolation, by attempting to infect the doctor with germs. In effect, this is what is believed to have happened with the widely-publicized Stuxnet cyber weapon. Stuxnet reportedly caused physical damage to specifically-targeted Iranian uranium-enrichment facilities. It demonstrated that the so-called air gap strategy does not always work.

Firewalls are not new and are used extensively. Applying a simple firewall to an industrial application is neither novel nor completely secure. Some such firewalls passively monitor traffic and filter out disallowed traffic; some do not include any encryption, software version monitoring or installing, or actual source verification (they may well verify source based on IP/MAC addresses which can be easily spoofed).

The network communication between devices in an industrial control network is typically through standard industrial protocols such as Modbus TCP, Ethernet/IP, ProfiNET, Object Linking and Embedding (OLE) for Process Control (OPC), Dynamic Data Exchange (DDE), or custom TCP/UDP protocols.

Normally, these protocols are not encrypted, and the source of incoming data is not verified in a secure manner. The presumption is that anything physically connected to the network must be “authorized”.

The security risk of concern here appears when someone connects a removable device, such as a diagnostic laptop, to perform a software update, configuration change, or to run diagnostics, or if someone temporarily connects third party SCADA systems for a short-term process.

If one of these “reloadable” components has been compromised, it may introduce malware to the industrial control network, in much the same way that the doctor may introduce germs into an ICU environment as discussed above. The Stuxnet worm used widely known hard-coded accounts on Siemens PLCs to modify the control software running on the PLCs. However, other types of systems are vulnerable as well.

Furthermore, the entire system may be vulnerable to Address Resolution Protocol (ARP) poisoning attacks, which can allow unauthorized sniffing of network traffic. Even simply replaying massive quantities of sniffed authorized traffic can result in a Denial of Service (DOS) attack.

The normal approach for network security would be to install a firewall, but in this case, the malicious code is executing on a system that resides inside the firewall.

A new security mechanism is needed to secure fielded control systems from even very sophisticated cyber threats delivered by possibly-compromised systems connected to isolated industrial control networks.

### 2. SUMMARY OF THE INVENTION

The invention relates to a specially designed SECURITY MODULE placed between the industrial control network and a device in the network, which is now referred to as a “protected” device. Preferably, each device in the network is connected to the network via a security module.

The security module mimics the Internet protocol (IP) configuration of the protected device to which it is connected, making it transparent in the network.

Each security module includes a private encryption key, accessible only to it (for example built into its hardware), and a signed public key that it will automatically share with other security modules discovered on the network. Preferably, the signature for the public key must come from a Certificate Authority that is verifiable by all the devices on the network (normally the maker of the security module). These keys permit the security module to perform asymmetric point-to-point encryption of traffic from the protected device to the corresponding security module for a target device node and to detect (and thus block) devices attempting to masquerade as valid communication participants.

These keys also permit the security module to verify the actual source of any packets to be from authorized network nodes (based not just on the IP/MAC address but on the actual asymmetric key pair of the source node).

Each security module is preferably able to monitor the software versions of its protected device. In that way, suppose (for example) that someone were to connect directly to a PLC or other protected device and upload a new version of software (with the possibility that malware could be inadvertently installed). Once the protected device is reconnected to the security module, the security module detects the modified software version at the protected device and either restores the software to a known valid configuration or denies any network access to the protected device.

Denial of Service (DoS) attacks based on network flooding may be rejected automatically based on (a) unauthorized source, and (b) maximum allowed bandwidth, which will prevent even a protected-device failure from causing network issues).

Each security module may support a Web interface for configuring the allowed communication protocols and sources/destinations for network traffic, submitting digitally signed software updates to be loaded on the protected device.

The security module may verify the signed update to the protected-device software; update its own known-good version of the protected-device software, and then load the updated software onto the protected device.

The web interface may be secured with one-time use passwords (OTP) generated either through a hardware device on site, through part of the on-site SCADA system, or through a telephone support system.

Each security module may be implemented as a dual Ethernet port embedded PC running OpenBSD (Linux, Qnx, or other POSIX OS could also be used, but BSD is preferred for licensing benefits) and PF/IPF for stateful packet filtering. (Again, other solutions such as IP-chains/IPtables are also possible, but GPL software should be avoided).

Industrial protocols are preferably modeled in the stateful packet inspection. One differentiator between the security module and standard firewalls is that the security module understands and can interpret normal industrial protocols, and can filter out traffic based on being a disallowed protocol or an unrecognized/unauthorized protocol. Moreover, if the information contents of a given packet do not actually conform to the putative protocol, then that packet will be set aside.

### 3. BRIEF DESCRIPTION OF THE DRAWINGS

FIG. 1 is a high-level block diagram intended to represent a typical prior-art industrial control NETWORK 100. For simplicity and ease of understanding, the industrial control network 100 is shown as a ring with various devices 105 “attached” to it.

FIG. 2 is a similar diagram in which each of the “attached” devices 105 is equipped with a security module 200 in accordance with the invention.

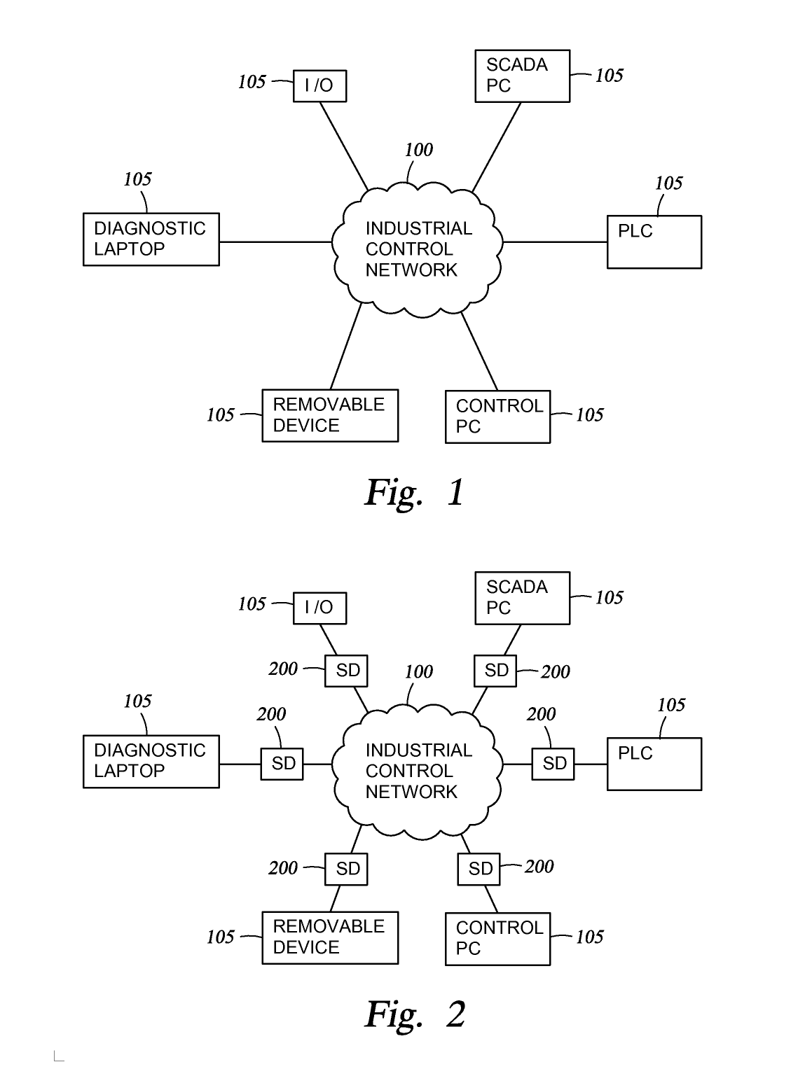

### 4. DETAILED DESCRIPTION OF SPECIFIC EMBODIMENTS

I describe below how to make and use some specific embodiments of the invention being claimed. In the interest of brevity and clarity, I focus on what might colloquially be called the ‘secret sauce,’ omitting various routine software design- and implementation details that would be apparent to (or readily discoverable by) suitably diligent persons of ordinary skill. I do not discuss, for example, the selection of appropriate programming languages for the various hardware components; the development of user interfaces except to a limited extent; considerations of data security; and the like.

4.1 Enhanced Firewalling

Referring to FIG. 2, the workings of one aspect of the invention can be understood in reference to a method—executed by a SECURITY MODULE 200 in an industrial control NETWORK 100—of processing an INFORMATION STREAM for possible delivery to a DEVICE 105, referred to for convenience as a protected device.

The protected device 105 may communicate with its security module 200 via a direct physical connection such as a cable connected to a port such as a serial port, a USB port, a Firewire port, and so on.

Or, the protected device may communicate with its security module 200 via a software interface such as a virtual network interface or an internal TCP socket. Techniques for making such connections are well-known to those of ordinary skill having the benefit of this disclosure.

The manner in which the security module 200 receives the information stream will of course depend on the nature of the connection between the security module and the network. For example, if the two are connected via an Ethernet network connection, the information stream will typically comprise a sequence of TCP packets.

The information stream consists of one or more PORTIONS.

The security module performs the following operations, possibly in parallel if the design of the security module supports parallel processing, and not necessarily in the order stated below.

ADDRESS CHECK: The security module 200 receives the information stream from the network and discards the information stream if it is not addressed to the protected device.

SOURCE CHECK: The security module 200 checks a list of allowed sources and, IF: The apparent source of the information stream does not match a source on the list of allowed sources; THEN: The security module 200 discards the information stream.

ANALOGY: A simplified analogy may be helpful. Imagine a group of workers in an aircraft assembly factory who are doing important and potentially-dangerous work such as attaching a wing to an aircraft body. For convenience, we will call these workers Alice, Bob, Carol, Dan, etc., in accordance with a common alphabetical-order convention used in computer science.

In this analogy, each worker represents a protected device. For purposes of this illustration, we will focus on Alice; a similar description would apply to our method in connection with Bob, Carol, Dan, etc.

Alice reads and follows written instructions that she receives periodically via inter-office mail. The inter-office mail system represents the network.

The possibility exists that an erroneous—or malicious—message might be delivered to Alice's in-box via inter-office mail. For example an erroneous or malicious message might tell Alice to stop using four bolts to fasten two parts of the aircraft wing together, but instead to use just one bolt.

Even if the inter-office mail system is not connected to the outside world, it is possible that an unauthorized agent could somehow sneak into the factory, perhaps using a stolen ID card, and drop a malicious message into the inter-office mail system, addressed to Alice.

It is also possible that Alice's training might not equip her to discern whether a message arriving in her in-box is legitimate or whether instead it is at least partially malicious.

For that reason, our hypothetical factory managers assign one or more specially-trained security monitors to help Alice, Bob, Carol, Dan, etc. These security monitors watch the workers' in-boxes for possible erroneous or malicious messages.

For example, suppose that the inter-office mail system delivers an envelope to Alice's in-box: Alice's security monitor—we will call him “Sam”—checks (i) whether the envelope is addressed to Alice, and (ii) whether the putative sender's name listed in the return address on the envelope is on a list of approved senders (for example the manager of the wing that Alice is helping to install on the aircraft). If either of these conditions is not satisfied, Sam sets aside the letter and does not give it to Alice.

In the contemplated implementations of the invention, the apparent source of the information stream—the return address on the envelope, so to speak—will be indicated by the IP ADDRESS and/or the MAC ADDRESS of the source as indicated in the information stream.

MODIFICATION CHECK: The security module 200 tests whether the information stream has apparently been modified in transit, and if so, discards it.

Continuing the analogy: Just because an envelope addressed to Alice has an allowed return address on it, that does not mean the envelope's contents are safe. Even if the envelope did originate at an allowed return address, the envelope might have been intercepted, and its contents modified, by a malicious agent.

So, Sam the security monitor checks the envelope for signs that the envelope might have been opened and re-sealed. If it appears that this has happened, then Sam sets the envelope aside and does not give it to Alice.

COMMUNICATIONS PROTOCOL CHECK: For each of one or more portions of the information stream, the security module 200 tests whether that portion does not conform to an allowed industrial COMMUNICATIONS PROTOCOL, and if so, discards that portion.

As is known to those of ordinary skill, the TCP specification requires an information stream to identify the protocol, or by analogy the “alphabet,” being used as part of the TCP header. The security module 200 may take advantage of that information by testing the information stream to assess whether the apparent protocol actually used matches the protocol identified in the TCP header. If not, the security module 200 may discard some or all of the information stream.

In our analogy, Alice's security monitor Sam checks to see whether the envelope indicates that its contents are written in an allowed alphabet—that is, an allowed industrial communications protocol—such as the Latin alphabet used in writing English-language documents.

If, let's say, the envelope says that its contents are written in a non-allowed alphabet such as the Cyrillic alphabet—or, if the envelope says that its contents are written in the Latin alphabet, but in fact those contents appear to be written in the Cyrillic alphabet—then Sam sets aside that envelope and does not give it to Alice.

In some situations, the allowed industrial communications protocols for a given allowed source might be restricted. Consider a simplified hypothetical example: The source module might discard an information stream from Allowed Source A if the information stream did not use either Allowed Protocol A or Allowed Protocol X, whereas the source module might discard an information stream from Allowed Source B if the information stream did not use either Allowed Protocol B or Allowed Protocol X.

INSTRUCTION CHECK: For each of one or more portions of the information stream, the security module 200 decodes the information content of that portion and tests the information content for the presence of one or more INSTRUCTIONS for the protected device.

Returning to our analogy: Suppose that Alice's existing instructions are to use four bolts to hold two pieces of an aircraft wing together. The contents of an envelope addressed to Alice by a malicious sender might include an “instruction” along the lines of, “Bolts: 1,” thus modifying Alice's previous instructions.

The information content decoded from the information stream can be tested for the presence of protected-device INSTRUCTIONS by checking it against a list of known instructions for the protected device.

If the information content does contain instructions for the protected device, then the security module 200 discards that portion of the information stream.

In our analogy, if Alice's security monitor Sam recognizes the presence of such an instruction in the envelope's contents, then he sets aside the envelope and its contents and does not give it to Alice.

DELIVERY: Finally, the security module 200 sends the contents of the undiscarded portions of the information stream, if any, to the protected device.

The security module 200 may also conventionally write, into a log, a summary and/or details of its test results and any action it took in processing the information stream.

ENCRYPTION: The security module 200 may assess whether one or more portions of the information stream are encrypted. If so, the security module 200 initiates an attempt to decrypt any encrypted portions, and discards one or more of the following: (i) any encrypted portion that was not successfully decrypted, and (ii) any portion of the information stream that is not encrypted.

The decryption attempt could be done by the security module 200 itself, or the security module 200 might “outsource” that job to a separate decryption module or other decryption capability.

DIGITAL SIGNATURE: The security module 200 may test whether the information stream includes a valid authorized digital signature and, not, discards the information stream.

Testing for a valid authorized digital signature increases the confidence that the information packet (i) is from a specific allowed source, and (ii) has not been modified in transit.

This is roughly analogous to the wax seal that a king might affix to a letter before sending it; the presence of the unbroken seal would give the recipient at least some confidence that the letter did indeed come from the king and had not been tampered with in transit.

SEPARATE COMMUNICATIONS PROTOCOL: The security module 200 may send at least the contents of the restricted instruction via a communications protocol for the protected device that differs from the communications protocol of the information stream.

4.2 Software Status Check

In another aspect of the invention, the protected device, as installed, includes installed software or other instructions that the protected device can follow. The instructions might take the form of one or more of computer software; programmable logic controller (PLC) software; or configuration information, for the purpose of, for example, controlling a drilling machine, a manufacturing robot, a nuclear power plant, etc.

The security module 200 sends a query to the protected device asking for the STATUS of its instructions.

The security module 200 receives a status response from the protected device.

The security module 200 compares the status response to one or more stored status profiles, each representing a known-good status for the instructions.

IF: The status response indicates that the status of the instructions does not conform to at least one such known-good status; THEN: The security module 200 takes a remedial action comprising one or more of the following: (1) sending an alarm message to a security station (not shown); (2) blocking access by the protected device to an industrial control network—to which the protected device might or might not be connected at the time—and (3) sending, to the protected device, instructions for restoring a known-good status.

The alarm message could be a text message, an email, an alert on a human-machine interface such as a screen display, an audible alarm, etc.

Some ways to block access include, for example, the following: Activating a firewall. Sending a message to a network firewall to block access by the protected device. Sending a message to the protected device to cease access to the network. Sending a message to the protected device to turn itself off. Switching off the power supply of the protected device.

Sending instructions for restoring a known-good status could include sending one or more of (i) a stored known-good software load, (ii) a software patch, (iii) a known-good configuration, and (iv) a configuration patch, for installation on the protected device.

4.3 Other Variations

SPECIAL PROTOCOL: In another aspect of the invention, IF: The information content of that portion of the information stream contains instructions for the protected device; AND: (i) The information stream was not addressed to the security module 200 itself, as distinct from the protected device; or: (ii) The information stream does not conform to a specified, possibly-secret protocol or “alphabet”; THEN: The security module 200 discards at least that portion of the information stream. This would provide at least some confidence that the restricted instruction came from an authorized source, on the theory that a malicious, unauthorized source would be less likely to know the network address of the security module 200 and to know the specified protocol.

FILTERING, SIGNING, AND/OR ENCRYPTING OUTBOUND TRAFFIC: Another advantage of the security module described here is that, in processing outbound traffic from the protected device, it can filter the traffic to eliminate or modify undesirable information streams. It can also digitally-sign and/or encrypt some or all portions of outgoing information streams using conventional techniques such as public- or private-key encryption, much as existing virtual private networks do.

NON-PROTECTED DEVICES: In some implementations, any given device 105 might be connected directly to the industrial control network 200, without having a security module 200 interposed between it and the network.

4.4 Programming; Program Storage System

The security module and method described may be implemented by providing suitable programming for a general-purpose computer having appropriate hardware. The programming may be accomplished through the use of a program storage system readable by the computer, either locally or remotely, where each program storage system encodes all or a portion of a program of instructions executable by the computer for performing the operations described above. The specific programming is conventional and can be readily implemented by those of ordinary skill having the benefit of this disclosure. A program storage system may take the form of, e.g., a hard disk drive, a flash drive, a network server (possibly accessible via Internet download), or other forms of the kind well-known in the art or subsequently developed. The program of instructions may be “object code,” i.e., in binary form that is executable more-or-less directly by the computer; in “source code” that requires compilation or interpretation before execution; or in some intermediate form such as partially compiled code. The precise forms of the program storage system and of the encoding of instructions are matters of design choice by those skilled in the art.

### 5. GLOSSARY

COMMUNICATIONS PROTOCOL: In this context, a communications protocol can be thought of as roughly analogous to a type of “alphabet,” that is, an agreed system of symbols that can be combined to form allowable words and messages for use in communications. By analogy, the Latin alphabet is used in the English words of this disclosure; it begins with the letters A, B, C, D, and E. The Cyrillic alphabet is used for, e.g., Russian; it begins with the letters A, [symbol] (Be), B (Ve), ┌ (Ge), and [symbol] (De). The Morse code alphabet begins with .-(A), -... (B), -.-. (C), - -. (D), and . (E). Some representative examples of industrial communications protocols or “alphabets” include: 1-Wire; ANSI C12.18; AS-i; BACnet; BSAP; C-Bus; CC-Link Industrial Networks; CIP (Common Industrial Protocol); ControlNet; Controller Area Network (CAN); Controller Area Network; DALI; DC-BUS[3]; DF-1; DLMS/IEC 62056; DNP3; DSI; DeviceNet; DirectNet; Dynet; EnOcean; EtherCAT; EtherNet/IP; Ethernet Global Data (EGD); Ethernet Powerlink; FINS; FOUNDATION fieldbus; FlexRay; GE SRTP; HART; Honeywell SDS; HostLink; IDB-1394; IEBus; IEC 60870-5; IEC 61107; IEC 61850; IEC 62351; Inter-bus; J1708; J1939 and ISO11783; Keyword Protocol 2000 (KWP2000); Konnex (KNX); Local Interconnect Network (LIN); LonTalk; M-Bus; MECHATROLINK; MTConnect; Media Oriented Systems Transport (MOST); MelsecNet; Modbus PEMEX; Modbus Plus; Modbus RTU or ASCII or TCP; Modbus; OPC UA; OPC; OSGP; Optomux; PROFINET IO; PieP; Profibus; Profibus; RAPIEnet; S-Bus; SERCOS III; SERCOS interface; SMARTwireX; Sinec H1; SynqNet; TTEthernet; VSCP; Vehicle Area Network (VAN); X10; ZigBee Smart Energy 2.0; ZigBee; oBIX; xAP. Various ones of these protocols are used in industrial controls; process automation; building automation; power system automation; automatic meter reading; and vehicles. Of course, other industrial communications protocols might exist now or be developed in the future.

DEVICE (105) refers generally to any device connected to a network, such as (for example) a programmable logic controller (PLC); a display or other human-machine interface; maintenance- and diagnostic systems such as laptop computers; various components or other elements of a supervisory control and data acquisition (SCADA) system; input-output aggregation modules; and the like.

INFORMATION STREAM generally refers to a sequence of one or more messages such as datagram packets.

INSTRUCTIONS, for this purpose, includes not only command-type instructions per se but also data values used in such instructions, or even pointers to locations where data values can be retrieved.

IP ADDRESS is a conventional term referring to the numerical Internet Protocol address assigned by a network to a given device on the network. A device's IP address is roughly equivalent to the street address of a given house.

MAC ADDRESS (short for Media Access Control address) is a conventional term referring to a unique identifier assigned to an item of hardware that can communicate over a network. The MAC address of a device is roughly equivalent to the Social Security number of an individual in the United States: It is (supposed to be) unique; it is assigned to the device during its manufacture, that is, very early in the device's lifetime; and in almost all cases it stays the same for the device's entire lifetime.

NETWORK (100) refers generally to a local area network, a wide area network, or a collection of local- and/or wide-area networks such as the Internet. For purposes of this discussion, the network is untrusted, that is, it is assumed that communications on the network could include harmful commands or information and/or that unauthorized systems and/or persons might able to “listen in” on the network or to send unauthorized information over the network.

PORTIONS: As an illustrative example, in the TCP protocol, an information stream generally comprises a plurality of packets; in such a case, each packet is considered a “portion” of the information stream. It will be apparent to those of ordinary skill having the benefit of this disclosure that an information stream could be divided into “portions” in other ways.

SECURITY MODULE (200) refers, in one embodiment, to an electronic device interposed between a protected DEVICE (105) and a NETWORK (100). Alternatively, the security module could be part of the software running on the protected device. In some implementations, a given security module 200 might serve as the intermediary between the industrial control network 100 and multiple protected devices 105.

STATUS: The status of a protected device's INSTRUCTIONS might include one or more of a version number; a time stamp; a hash of the software code itself; configuration information; and so forth.

We claim:

1. A method—executed by a SECURITY MODULE (200) in an industrial control NETWORK (100)—of processing an INFORMATION STREAM for possible delivery to a DEVICE (105), referred to as a protected device;
in which the information stream consists of one or more PORTIONS;
and in which the method comprises the following:
(a) The security module receives the information stream from the network;
(b) The security module tests for one or more of the following conditions and, if such testing indicates that a tested condition exists, then the security module discards the information stream:
(1) whether the information stream is not addressed to the protected device;
(2) whether the source of the information stream does not match any listed source in a list of allowed sources; and
(3) whether the information stream has been modified in transit;
(c) For each of one or more portions of the information stream, the security module tests for one or more of the following conditions and, if such testing indicates that any of the tested conditions is present, then the security module discards that portion of the information stream:
(1) whether that portion of the information stream does not conform to any listed industrial COMMUNICATIONS PROTOCOL in a list of allowed protocols; and
(2) whether the information content of that portion of the information stream includes one or more INSTRUCTIONS for the protected device; and
(d) The security module sends the contents of the undiscarded portions of the information stream, if any, to the protected device.

2. The method of claim 1, wherein in addition: The security module assesses whether one or more portions of the information stream are encrypted, and if so,
(i) initiates an attempt to decrypt any encrypted portions, and
(ii) discards any encrypted portion that was not successfully decrypted.

3. The method of claim 2, wherein:
(i) At least a portion of the information stream is encrypted; and
(ii) The security module discards any portion of the information stream that is not encrypted.

4. The method of claim 2, wherein: The security module discards any portion of the information stream that is not encrypted.

5. The method of claim 1, wherein: The security module tests whether the information stream includes a valid authorized digital signature and, not, discards the information stream.

6. The method of claim 1, wherein: IF: The security module sends the contents of undiscarded portions of the information stream to the protected DEVICE; AND: The undiscarded portions include one or more INSTRUCTIONS for the protected device; THEN: The security module sends at least one such instruction to the protected device using a COMMUNICATIONS PROTOCOL that differs from the communications protocol of the information stream.

7. A method, executed by a SECURITY MODULE (200), in which:
(1) The security module is connected to a DEVICE (105), referred to as a protected device;
(2) The protected device includes a set of instructions that the protected device can follow;
and the method comprises:
(a) The security module sends a query to the protected device asking for the STATUS of its instructions;
(b) The security module receives a status response from the protected device;
(c) The security module compares the status response to one or more stored status profiles, each representing a known-good status for the instructions;
(d) IF: The status response indicates that the status of the instructions does not conform to at least one known-good status; THEN: The security module takes a remedial action comprising one or more of the following:
(1) sending an alarm message to a security station;
(2) blocking access by the protected device to an industrial control NETWORK (100);
(3) sending, to the protected device, instructions for restoring a known-good status.

8. A method—executed by a SECURITY MODULE (200) in an industrial control NETWORK (100)—of processing an INFORMATION STREAM for possible delivery to a DEVICE (105), referred to as a protected device;
in which the information stream consists of one or more PORTIONS;
and the method comprises the following:
(a) The security module receives the information stream from the network;
(b) The security module tests for one or more of the following conditions and, if such testing indicates that any of the tested conditions is present, then the security module discards the information stream:
(1) whether the source of the information stream does not match any listed source in a list of allowed sources; and
(2) whether the information stream has been modified in transit;
(c) For each of one or more portions of the information stream, the security module tests whether that portion does not conform to an allowed industrial COMMUNICATIONS PROTOCOL, and if so, discards that portion;
(d) For each of one or more portions of the information stream, the security module decodes the information content of that portion and tests the information content for the presence of one or more INSTRUCTIONS for the protected device;
(e) IF: (i) the information content of that portion of the information stream does contain instructions for the protected device; AND: (ii) The information stream was not addressed to the security module; THEN: (iii) The security module discards at least that portion of the information stream; and
(f) The security module sends the contents of the undiscarded portions of the information stream, if any, to the protected device.

9. The method of claim 8, wherein: The security module tests whether the one or more instructions for the protected device contained in the portion of the information stream is likely to be a safe instruction, and if not, discards at least that portion of the information stream.

10. A SECURITY MODULE (200) wherein:
(a) the security module contains (1) a computer-readable program storage system and (2) one or more processors;
(b) the program storage system contains a program of instructions, readable by one or more of the processors; and
(c) the program storage system contains a program of instructions for the security module to carry out the operations described in a specified one of claims 1 through 9.

11. A computer-readable program storage system, wherein:
(a) The program storage system is readable by a SECURITY MODULE (200); and
(b) the program storage system contains a program of instructions for the security module to carry out the operations described in a specified one of claims 1 through 9.

12. An industrial control NETWORK (100) comprising a plurality of DEVICES (105) and a plurality of SECURITY MODULES (200), where:
(a) each device is connected to the industrial control network via a security module;
(b) each security module contains one or more processors;
(c) each security module is connected to a program storage system;
(d) each program storage system contains a program of instructions, readable by one or more processors in the security module; and
(e) execution of the program of instructions, by one or more processors of the security module, causes the security module to carry out the operations described in a specified one of claims 1 through 8.

13. The industrial control network of claim 12, wherein each SECURITY MODULE connects exactly one DEVICE to the network.

14. The industrial control network of claim 12, wherein each of the plurality of DEVICES is connected to the network via a SECURITY MODULE.
